(19) United States
(12) Patent Application Publication
(10) Pub. No.: US 2008/0074963 A1
(43) Pub. Date: Mar. 27, 2008

(54) OPTICAL PICKUP DEVICE AND OPTICAL DISK DEVICE

(75) Inventors: Kenji NAGATOMI, Kaidu-City (JP); Katsutoshi HIBINO, Kaidu-City (JP); Shogo SUZUKI, Mizuho-City (JP)

Correspondence Address: DITTHAVONG MORI & STEINER, P.C., 918 Prince St., Alexandria, VA, 22314, US

(73) Assignee: Sanyo Electric Co., Ltd., Moriguchi-shi (JP)

(21) Appl. No.: 11/861,938

(22) Filed: Sep. 26, 2007

(30) Foreign Application Priority Data
Sep. 27, 2006 (JP) 2006-263553

(51) Int. Cl. G11B 7/00

(52) U.S. Cl. 369/44.11; 369/112.02; 369/112.03

(57) ABSTRACT

A polarizing diffraction element is disposed between a photodetector and a liquid crystal lens to impart diffraction action to light reflected from a disk. The polarizing diffraction element is configured such that a focal distance of diffracted light having a predetermined order of the reflected light when the liquid crystal lens is in a first driving state is equalized to a focal distance of 0-order diffracted light of the reflected light when the liquid crystal lens is in a second driving state.

This application claims priority under 35 U.S.C. Section 119 of Japanese Patent Application No. 2006-263553 filed Sep. 27, 2006, entitled “OPTICAL PICKUP DEVICE AND OPTICAL DISK DEVICE”.

### BACKGROUND OF THE INVENTION

1. Field of the Invention

The present invention relates to an optical pickup device and an optical disk device into which the optical pickup device is incorporated, particularly to the optical pickup device and optical disk device which are suitable for use in guiding a laser beam to optical disks having different thicknesses with one objective lens.

2. Description of the Related Art

Currently, a DVD (Digital Versatile Disc) is commercialized and widely spread as the optical disk. Furthermore, a HDDVD (High-Definition Digital Versatile Disc) and a BD (Blue-ray Disc) which have the larger capacities are being developed for commercialization. In such optical disks, although the DVD and the HDDVD have the same substrate thickness, the BD has a substrate thickness smaller than those of other disks. Therefore, in the case where the laser beam is caused to converge on the BD and other disks by a common objective lens, it is necessary that a focal position be changed back and forth according to the different substrate thicknesses.

For example, the following method is known as a method for realizing the change of the focal position according to the different substrate thicknesses. In the method, a spread angle of the laser beam is changed using a liquid crystal lens whose driving is dynamically controlled when the laser beam is incident on an objective lens. When the liquid crystal lens is turned off, the liquid crystal lens does not impart diffuse action to the laser beam, and the laser beam is guided in parallel light to the objective lens. When the liquid crystal lens is turned on, the liquid crystal lens has the diffuse action on the laser beam, and the laser beam is guided to the objective lens while diffused compared with the parallel light. The ON/OFF control of the liquid crystal lens permits the state of the laser beam incident on the objective lens to switch between a finite conjugated system (diffuse light) and an infinite conjugated system (parallel light). Therefore, the focal position of the laser beam through the objective lens is changed back and forth.

However, in the method, because the laser beam is caused to converge on the disk in linearly polarized light, there is generated a problem in that large aberration is produced in the laser beam based on birefringence. In order to avoid the problem, it is necessary that a quarter-wave plate be inserted between the liquid crystal lens and the objective lens to cause the laser beam to impinge on the objective lens in circularly polarized light. In this case, after the laser beam reflected from the disk passes through the quarter-wave plate, a polarization direction of the laser beam is orthogonal to a polarization direction of the laser beam in traveling to the disk, so that the liquid crystal lens does not have the diffuse action on the reflected light. As a result, the convergent position of the reflected light in turning on the liquid crystal lens and the convergent position of the reflected light in turning off the liquid crystal lens are not coincident with each other in an optical axis direction, which causes a problem in that the light reflected from the DVD or the HDDVD and the light reflected from the BD cannot smoothly be received with one photodetector.

For example, the problem is solved by disposing the two liquid crystal lenses which separately act on the laser beam in a path through which the laser beam travels to the disk and in a path through which the laser beam travels from the disk to the photodetector. However, in this case, production cost is increased because of the need for disposing the additional liquid crystal lens in the path through which the laser beam travels from the disk to the photodetector. Furthermore, the number of times at which the laser beam passes through the liquid crystal lens is increased by one in each of the path through which the laser beam travels to the disk and the path through which the laser beam travels from the disk to the photodetector, which results in a problem of largely lowering a power of the laser beam with which the disk is irradiated and a power of the laser beam guided to the photodetector.

### SUMMARY OF THE INVENTION

A first aspect of the present invention relates to an optical pickup device. The optical pickup device according to the first aspect of the present invention includes a light source which emits a laser beam having a predetermined wavelength; a polarization beam splitter on which the laser beam is incident; an objective lens which causes the laser beam through the polarization beam splitter to converge; a quarter-wave plate which is disposed between the polarization beam splitter and the objective lens; a liquid crystal lens which is disposed between the polarization beam splitter and the quarter-wave plate to switch between a first driving state and a second driving state, diffuse action being imparted to the laser beam by a control signal in the first driving state, diffuse action being not imparted to the laser beam in the second driving state; a photodetector which accepts light reflected from a disk; and a polarizing diffraction element which is disposed between the photodetector and the liquid crystal lens, wherein the polarizing diffraction element is configured such that a focal distance of diffracted light having a predetermined order of the reflected light when the liquid crystal lens is in the first driving state is equalized to a focal distance of 0-order diffracted light of the reflected light when the liquid crystal lens is in the second driving state.

A second aspect of the present invention relates to an optical disk device. The optical disk device according to the second aspect of the present invention includes the optical pickup device according to the first aspect of the present invention; a servo circuit which supplies the control signal to the liquid crystal lens; and a disk determination circuit which makes a determination between types of the loaded disks to supply a signal to the servo circuit according to determination result.

### BRIEF DESCRIPTION OF THE DRAWINGS

The above and other objects and novel features of the present invention will be apparent from the following detailed description of preferred embodiments of the present invention in conjunction with the accompanying drawings.

FIG. 1 shows a configuration of an optical disk device according to an embodiment of the present invention;

FIG. 2 illustrates configurations of a polarizing diffraction element and a liquid crystal lens according to the embodiment;

FIGS. 3A and 3B illustrate diffraction structures of the polarizing diffraction element and liquid crystal lens according to the embodiment respectively;

FIG. 4 illustrates diffraction efficiency of the polarizing diffraction element according to the embodiment;

FIGS. 5A and 5B show loci of a laser beam toward a disk and the laser beam reflected from the disk when the liquid crystal lens according to the embodiment is turned on respectively;

FIGS. 6A and 6B show loci of the laser beam toward the disk and the laser beam reflected from the disk when the liquid crystal lens according to the embodiment is turned off respectively;

FIG. 7 shows a modification of the polarizing diffraction element according to the embodiment;

FIG. 8 illustrates diffraction efficiency of a polarizing diffraction element according to the embodiment; and

FIG. 9 is a flowchart showing a disk determination method according to the embodiment.

However, the drawings are used for the purpose of illustration only, and the drawings are not intended to restrict the scope of the present invention.

### DESCRIPTION OF THE PREFERRED EMBODIMENTS

A preferred embodiment of the present invention will be described below with reference to the drawings. In the embodiment, the present invention is applied to a compatible optical pickup device which is capable of a HDDVD (hereinafter referred to as “HD”) having a substrate thickness of 0.6 mm and a BD having a substrate thickness of 0.1 mm and an optical disk device onto which the optical pickup device is incorporated.

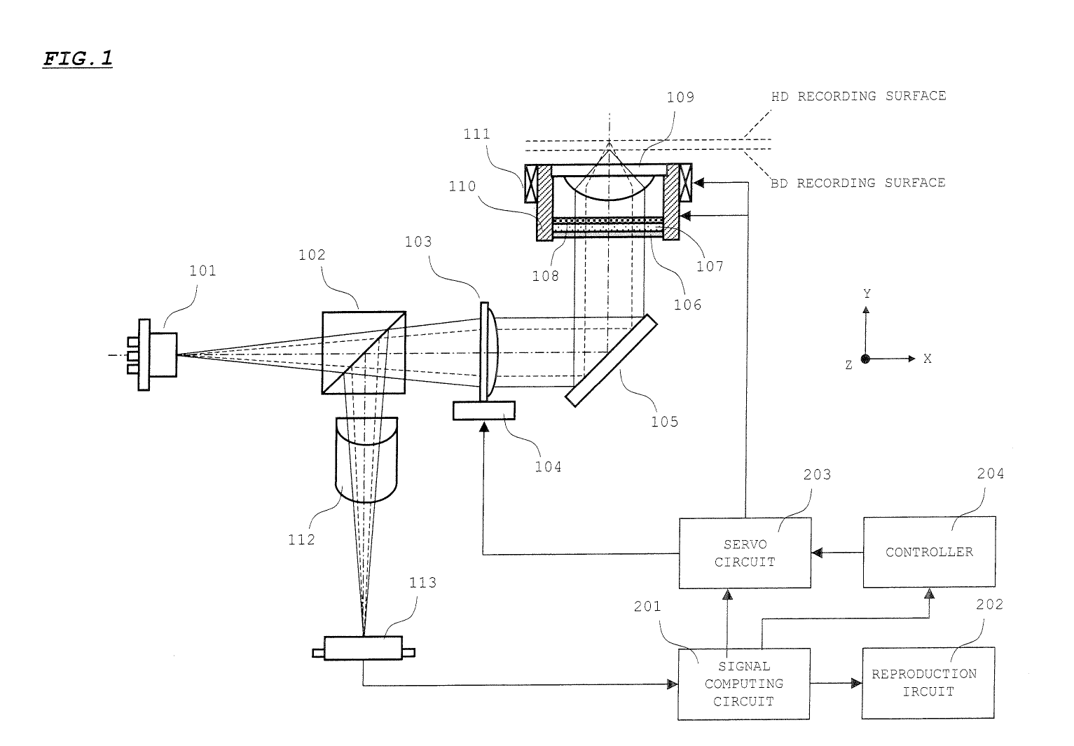

FIG. 1 shows an optical system of the optical pickup device according to the embodiment and a circuit configuration of an optical disk device related to the optical pickup device.

Referring to FIG. 1, the optical system of the optical pickup device includes a semiconductor laser 101, a polarization beam splitter 102, a collimate lens 103, a lens actuator 104, a rise mirror 105, a polarizing diffraction element 106, a liquid crystal lens 107, a quarter-wave plate 108, an objective lens 109, a holder 110, an objective lens actuator 111, a detection lens 112, and a photodetector 113. In addition to the optical pickup device having the above optical system, the optical disk device further includes a signal computing circuit 201, a reproduction circuit 202, a servo circuit 203, and a controller 204.

The semiconductor laser 101 emits a laser beam having a wavelength of about 405 nm. The polarization beam splitter 102 substantially totally transmits the laser beam (P-polarization) incident from the semiconductor laser 101 and substantially totally reflects the laser beam (S-polarization) incident from a side of the collimate lens 103. The collimate lens 103 converts the laser beam incident from a side of the polarization beam splitter 102 into parallel light. The lens actuator 104 displaces the collimate lens 103 in an optical axis direction in response to a servo signal inputted from the servo circuit 203. Therefore, aberration generated in the laser beam can be corrected. The rise mirror 105 reflects the laser beam incident from the side of the collimate lens 103 toward a direction of the objective lens 109.

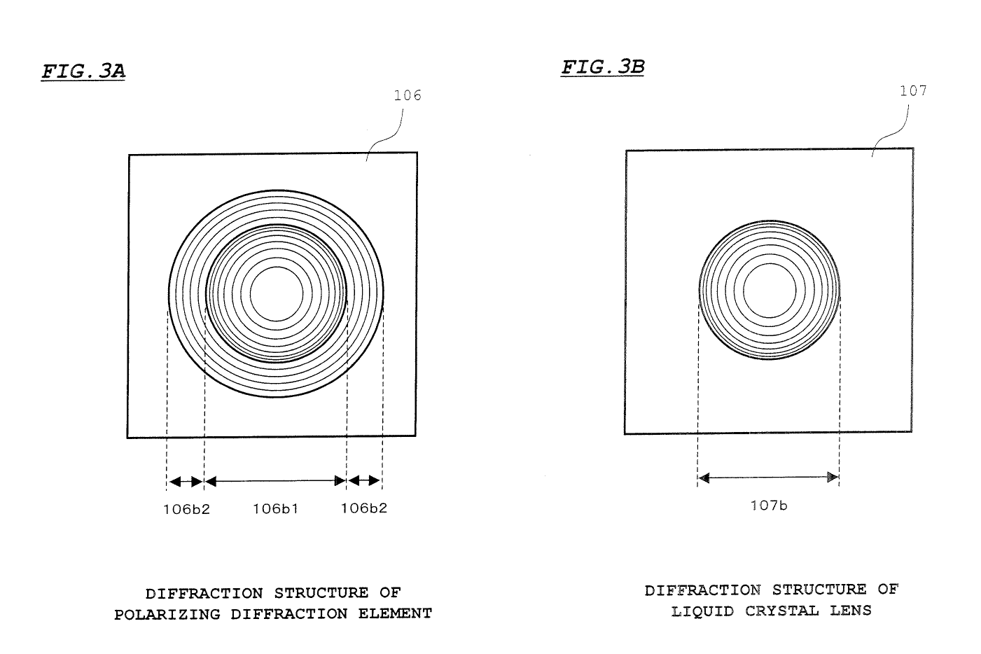

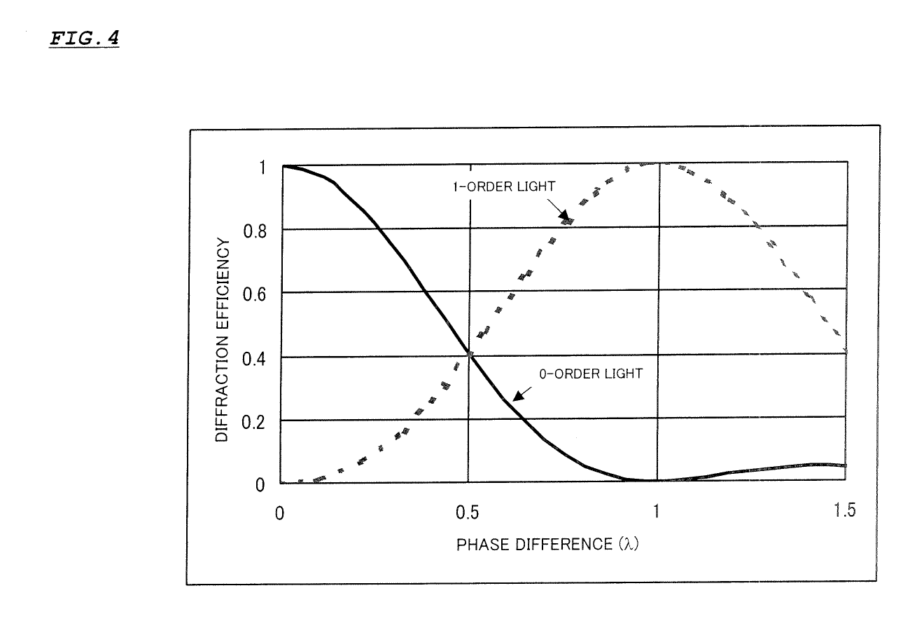

The polarizing diffraction element 106 imparts diffraction action to the S-polarized laser beam. The liquid crystal lens 107 imparts diffuse action to the P-polarized laser beam. The configurations of the polarizing diffraction element 106 and liquid crystal lens 107 will be described later with reference to FIGS. 3A, 3B, and 4.

The quarter-wave plate 108 converts the laser beam traveling to the disk into circularly polarized light, and the quarter-wave plate 108 converts the light reflected from the disk into linearly polarized light orthogonal to the polarization direction of the light traveling to the disk. In the embodiment, the polarizing diffraction element 106, the liquid crystal lens 107, and the quarter-wave plate 108 are integrally formed.

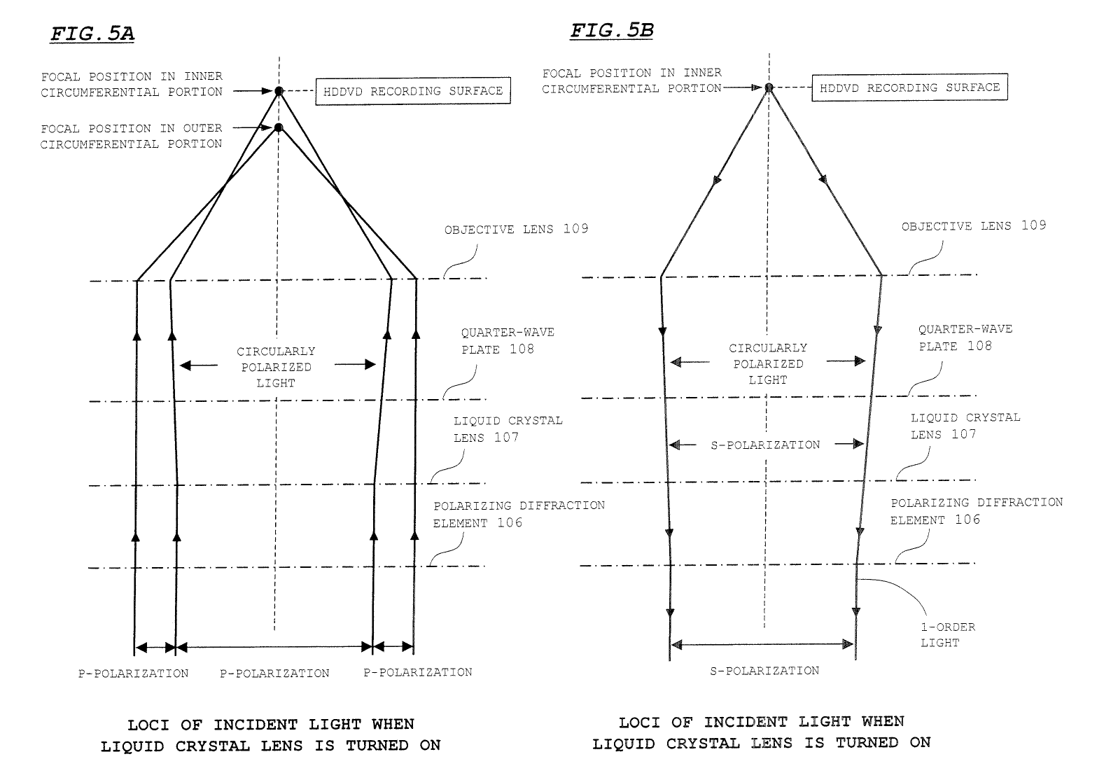

The objective lens 109 is designed to be able to cause the laser beam to converge properly on to the BD recording surface. When the optical disk device is capable of the BD, the laser beam is incident on the objective lens 109 in the state of the infinite conjugated system (parallel light). On the other hand, when the optical disk device is capable of the HD, the laser beam is restricted by an aperture and incident on the objective lens 109 in the state of the finite conjugated system (diffuse light). Therefore, when the optical disk device is capable of the HD, the convergent position of the laser beam is separated farther away from the objective lens 109 compared with the case in which the optical disk device is capable of the BD. When the optical disk device is capable of the HD, an aperture restriction action and diffuse action are adjusted such that the laser beam converges properly onto the HD. The liquid crystal lens 107 exerts the aperture restriction action and diffuse action. The aperture restriction action and diffuse action will be described later with reference to FIG. 5.

The holder 110 integrally retains the polarizing diffraction element 106, the liquid crystal lens 107, the quarter-wave plate 108, and the objective lens 109. The objective lens actuator 111 is formed by a conventional electromagnetic driving circuit, and a coil portion such as a focus coil in the electromagnetic driving circuit is attached to the holder 110.

The detection lens 112 causes the light reflected from the disk to converge onto the photodetector 113. The detection lens 112 includes a collective lens and a cylindrical lens to introduce astigmatism to the light reflected from the disk. The photodetector 113 has a sensor pattern for deriving a reproduction RF signal, a focus error signal, and a tracking error signal from an intensity distribution of the received laser beam. The signal from each sensor is outputted to the signal computing circuit 201. In the photodetector 113, a position of a light receiving surface is adjusted so as to received the reflected light incident on the collimate lens 103 in the form of the parallel light.

The signal computing circuit 201 generates a reproduction RF signal, a focus error signal, and a tracking error signal by performing a computing process to a sensor signal inputted from the photodetector 113, and thus the signal computing circuit 201 outputs the reproduction RF signal, the focus error signal, and the tracking error signal to the corresponding circuits.

The reproduction circuit 202 generates reproduction data by demodulating the reproduction RF signal inputted from the signal computing circuit 201. The servo circuit 203 generates a tracking servo signal and a focus servo signal from the tracking error signal and focus error signal which are inputted from the signal computing circuit 201, and the servo circuit 203 outputs the tracking servo signal and focus servo signal to the objective lens actuator 111. The servo circuit 203 also outputs a driving signal to the liquid crystal lens 107 in response to a command from the controller 204.

The controller 204 makes a determination between the disks according to the focus error signal inputted from the signal computing circuit 201, and the controller 204 a command signal to the servo circuit 203 according to the determination result. The command signal is used to control the driving state of the liquid crystal lens 107. The disk determination method performed by the controller 204 will be described later.

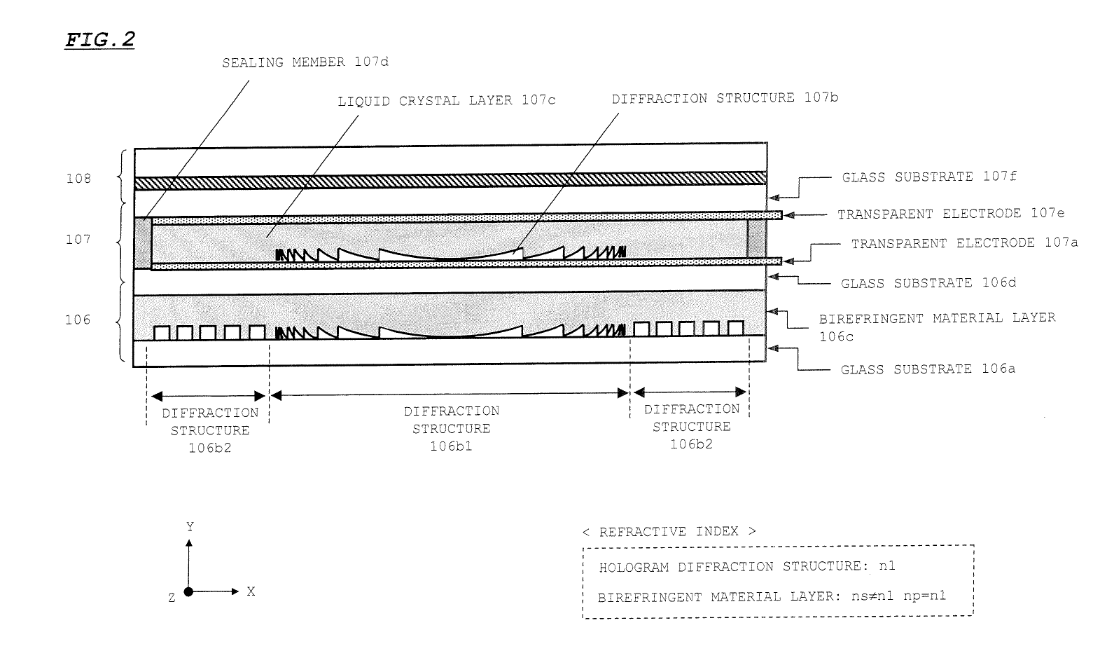

FIG. 2 shows sectional structures of the polarizing diffraction element 106 and liquid crystal lens 107. As described above, because the polarizing diffraction element 106 and the liquid crystal lens 107 are integral with the quarter-wave plate 108, FIG. 2 also shows a part of the quarter-wave plate 108. FIG. 2 shows the sectional structures when the structure including the polarizing diffraction element 106, the liquid crystal lens 107, and the quarter-wave plate 108 of FIG. 1 is cut in a plane parallel to a Y-Z plane.

As shown in FIG. 2, in the polarizing diffraction element 106, diffraction structures 106b1 and 106b2 are formed on a glass substrate 106a by a hologram, and a birefringent material layer 106c and a glass substrate 106d are sequentially formed on the diffraction structures 106b1 and 106b2.

Assuming that np is a refractive index of the birefringent material layer 106c when the laser beam is incident with P-polarization, ns is a refractive index of the birefringent material layer 106c when the laser beam is incident with S-polarization, and n1 is a refractive index of the diffraction structures 106b1 and 106b2, the refractive indexes are set such that relationships of np=n1 and ns≠n1 hold. Accordingly, in the case where the laser beam having the P-polarization is incident on the polarizing diffraction element 106, because a difference is not generated between the refractive index (n1) of the diffraction structures 106b1 and 106b2 and the refractive index (np) of the birefringent material layer 106c, the diffraction structures 106b1 and 106b2 do not act as a diffraction grating. On the other hand, in the case where the laser beam having the S-polarization is incident on the polarizing diffraction element 106, because the difference is generated between the refractive index (n1) of the diffraction structures 106b1 and 106b2 and the refractive index (ns) of the birefringent material layer 106c, the diffraction structure 106b acts as the diffraction grating.

As shown in FIG. 3A, the diffraction structures 106b1 and 106b2 are formed in a coaxial ring shape. FIG. 3A schematically shows the diffraction structures 106b1 and 106b2 when viewed from a Y-axis direction of FIG. 2.

In these two diffraction structures, the diffraction structure 106b1 on an inner circumferential side is formed in a blaze-type diffraction structure having a constant height, and the diffraction structure 106b2 on an outer circumferential side is formed in a stepwise diffraction structure having a constant height. The diffraction structure 106b1 diffuses +1-order diffracted light by the same lens effect as the lens effect imparted by the liquid crystal lens 107. The diffraction structure 106b2 causes ±1-order diffracted light to diverge onto the outer circumferential side and inner circumferential side. When the laser beam is incident on the objective lens, an effective diameter of the laser beam is equal to or slightly smaller than an outer diameter of a region where the diffraction structure 106b2 is formed.

The diffraction structure 106b1 is configured to impart diffraction action generated only by 0-order diffracted light (hereinafter referred to as “0-order light”) and +1-order diffracted light (hereinafter referred to as “1-order light”) to the laser beam. The diffraction structure 106b2 is configured such that diffraction efficiency of the 0-order light becomes equal to diffraction efficiency of the 1-order light.

FIG. 4 shows a simulation of a relationship between the diffraction efficiency and a phase difference generated in the diffraction structure 106b1. The diffraction structure 106b1 is configured such that the phase difference becomes 0.5(λ). In this case, the 0-order light and the 1-order light have the diffraction efficiency of about 0.4. At this point, the diffraction structure 106b2 on the outer circumferential side is configured such that the 0-order light has the diffraction efficiency of about 0.4.

The configuration of the liquid crystal lens 107 will be described with reference to FIG. 2. The liquid crystal lens 107 is formed by enclosing a liquid crystal between transparent electrodes 107a and 107e with a sealing member 107d. The transparent electrode 107a has a blaze-type diffraction structure 107b in an upper surface thereof, and the transparent electrode 107e faces the transparent electrode 107a. Orientation films (not shown) are formed to align orientation directions of liquid crystal molecules in a liquid crystal layer 107c in an inside surface of the transparent electrode 107e, an upper surface of the diffraction structure 107b, and a portion where the diffraction structure 107b is not formed in the inside surface of the transparent electrode 107a.

As shown in FIG. 3B, the diffraction structure 107b is formed in the coaxial ring shape. FIG. 3B schematically shows the diffraction structure 107b when viewed from the Y-axis direction of FIG. 2. The diffraction structure 107b has the same shape or pattern as the diffraction structure 106b1 formed in the polarizing diffraction element 106. The diffraction structure 107b exerts the function of the diffraction grating when the P-polarized laser beam is incident. Therefore, the diffraction structure 107b imparts the P-polarized laser beam the same lens action (diffuse action) as that imparted to the S-polarized laser beam by the diffraction structure 106b1. The diameter of the region where the diffraction structure 107b is formed is equal to or slightly larger than the diameter of the region where the diffraction structure 106b1 is formed.

The refractive index of the liquid crystal layer 107c for the incident laser beam having the P-polarization is equal to the refractive index of the diffraction structure 107b when voltage is not applied between the transparent electrodes 107a and 107e. In this case, because a boundary is not generated by the difference in refractive index between the liquid crystal layer 107c and the diffraction structure 107b, the diffraction structure 107b does not act as the diffraction grating, and the lens effect for the laser beam is not generated.

On the other hand, when the voltage is applied between the transparent electrodes 107a and 107e, an orientation state of the liquid crystal molecule is changed in the liquid crystal layer 107c, which changes the refractive index of the liquid crystal layer 107c for the P-polarization. This enables the boundary to be generated by the difference in refractive index between the liquid crystal layer 107c and the diffraction structure 107b to cause the diffraction structure 107b to act as the diffraction grating. As a result, the diffraction structure 107b has the lens effect on the laser beam.

The diffraction structure 107b is configured such that the diffraction efficiency of the +1-order light becomes substantially 100%. Therefore, when the laser beam (P-polarization) is incident on the liquid crystal lens 107 from the Y-axis direction of FIG. 2, the diffraction structure 107b has the diffuse action on the laser beam while the diffraction efficiency is not attenuated. The diffraction structure 107b is formed in the shape, in which the parallel light (P-polarization) incident from a side of the polarizing diffraction element 106 is diffused so as to be caused to converge properly onto the HD recording surface by the objective lens 109. The pattern of the diffraction structure 107b is adjusted so as to be able to suppress an aberration of the +1-order light on the HD recording surface.

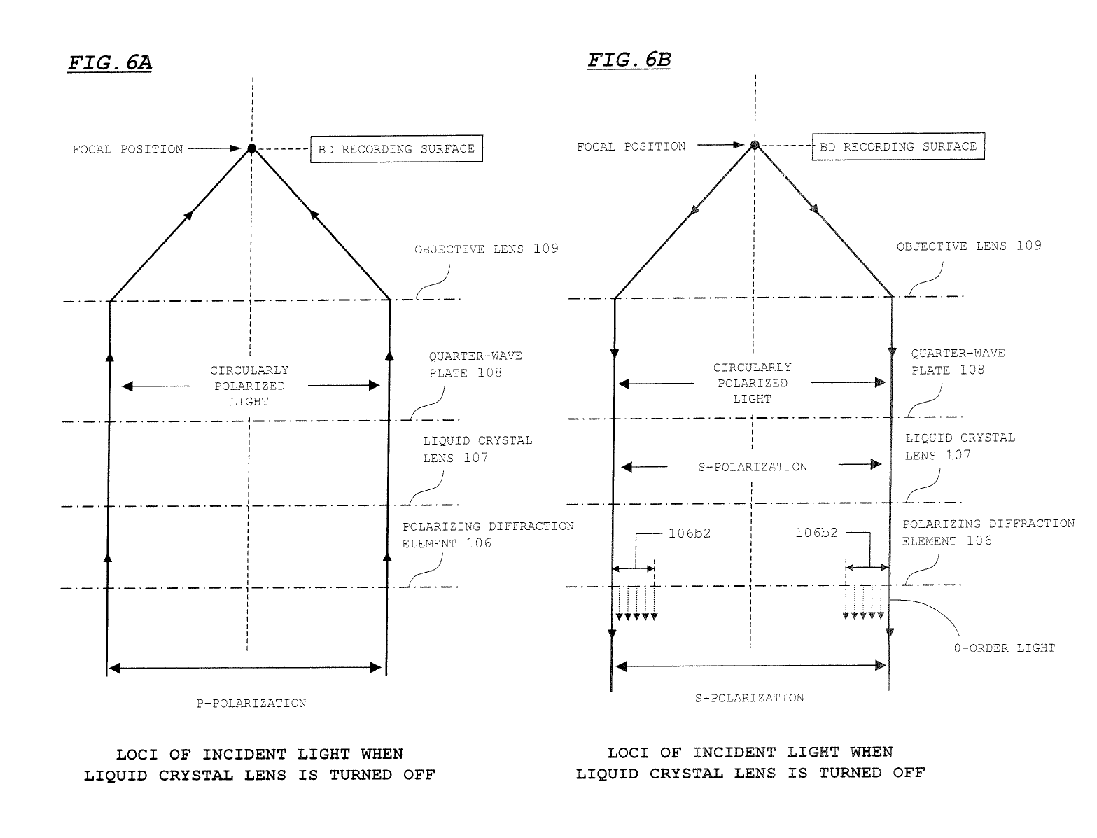

The state of the laser beam in ON/OFF control of the liquid crystal lens 107 will be described with reference to FIGS. 5 and 6. FIGS. 5A and 5B show the states of the incident laser beam and reflected laser beam when the liquid crystal lens 107 is turned on, and FIGS. 6A and 6B show the state of the incident laser beam and reflected laser beam when the liquid crystal lens 107 is turned off. The liquid crystal lens 107 is set to the ON-state when the HD is the reproduction target disk, and the liquid crystal lens 107 is set to the OFF-state when the BD is the reproduction target disk.

Referring to FIG. 5A, when the liquid crystal lens 107 is turned on, the laser beam (P-polarization) passes through polarizing diffraction element 106 while the parallel light is maintained, and the laser beam is incident on the liquid crystal lens 107. At this point, the diffraction structure 107b of the liquid crystal lens 107 has the diffraction action on an inner circumferential portion of the laser beam, and the liquid crystal lens 107 does not have the diffraction action on the inner circumferential portion of the laser beam because an outer circumferential portion of the laser beam does not pass through the diffraction structure 107b. Therefore, after passing through the liquid crystal lens 107, the inner circumferential portion of the laser beam is further diffused compared with the parallel light, and the outer circumferential portion is maintained in the parallel light state. As a result, the inner circumferential portion and outer circumferential portion of the laser beam are caused to converge at different positions on the optical axis by the objective lens 109.

Thus, when the liquid crystal lens 107 is turned on, the two focal positions are generated on the optical axis. In this case, the objective lens 109 is servo-controlled such that the focal position in the inner circumferential portion of the laser beam is pulled in the HD recording surface.

A pull-in operation to the HD recording surface is performed by referring to an S-shape curve on the focus error signal. When the objective lens 109 is moved in optical axis direction during focus search, the two S-shape curves emerge on the focus error signal at timing when the two focal positions are located on the HD recording surface respectively. In the S-shape curve corresponding to the focal position in the outer circumferential portion of the laser beam, amplitude does not become too large because the intensity distribution is small in the outer circumferential portion of the laser beam. On the other hand, in the S-shape curve corresponding to the focal position in the inner circumferential portion of the laser beam, because the intensity distribution is large in the inner circumferential portion of the laser beam, the amplitude becomes several times the S-shape curve corresponding to the focal position in the outer circumferential portion of the laser beam. Accordingly, in the S-shape curves generated on the focus error signal, when the focus pull-in operation is performed to the S-shape curve whose amplitude becomes the maximum, the focal position in the inner circumferential portion of the laser beam can be pulled in the HD recording surface.

When the focal position in the inner circumferential portion of the laser beam can be pulled in the HD recording surface, the light in the outer circumferential portion of the laser beam becomes remarkably fuzzy on the HD recording surface. Therefore, even if the HD recording surface is irradiated with the fuzzy light, and even if the reflected light is incident on the photodetector 113, the light in the outer circumferential portion of the laser beam has a little influence on the servo operation and reproduction operation of the objective lens 109. That is, the light in the outer circumferential portion of the laser beam is equivalent to the substantially-cut light, and only the light in the inner circumferential portion of the laser beam becomes effective.

When the light is incident on the objective lens 109, the effective diameter of the light in the inner circumferential portion of the laser beam corresponds to a numerical aperture (NA) which is determined when the optical disk device is capable of the HD. That is, the diameter of the region where the diffraction structure 107b provided in the liquid crystal lens 107 is formed is adjusted such that the diameter in the inner circumferential portion of the laser beam incident on the objective lens 109 corresponds to the numerical aperture (NA) which is determined when the optical disk device is capable of the HD.

The light in the inner circumferential portion of the laser beam which is caused to converge on the HD recording surface follows a path shown in FIG. 5B after the light is reflected from the HD recording surface. That is, the reflected light is incident on the liquid crystal lens 107 through the objective lens 109 and the quarter-wave plate 108. However, because the reflected light is S-polarized by the action of the quarter-wave plate 108, the liquid crystal lens 107 has no influence on the reflected light, and the reflected light passes through the liquid crystal lens 107 in convergent light. Then, the reflected light is incident on the diffraction structure 106b1 in the polarizing diffraction element 106. Because the reflected light is in the S-polarization state unlike the case in which the light travels to the disk, the diffraction structure 106b1 has the lens action (diffuse action) on the reflected light. As described above, because the diffraction efficiency of the 0-order light and the diffraction efficiency of the 1-order light are set to 0.4 respectively in the diffraction structure 106b1, a ratio of the light (1-order light) which becomes the parallel light by influence of the lens action from the diffraction structure 106b1 and the light (0-order light) which travels in convergent light without the lens action becomes 1:1.

In the embodiment, as described above, the position of the light receiving surface of the photodetector 113 is adjusted so as to receive the reflected light in parallel light which is incident on the collimate lens 103. Therefore, as shown in FIG. 5B, the light (1-order light) which becomes the parallel light by the lens action of the diffraction structure 106b1 is caused to converge onto the photodetector 113. In this case, the light (0-order light) which travels in convergent light without the lens action becomes remarkably fuzzy on the light receiving surface of the photodetector 113. Therefore, even if the remarkably fuzzy light is incident on the photodetector 113, the remarkably fuzzy light has the little influence on the sensor signal.

The case in which the liquid crystal lens 107 is turned off will be described with reference to FIGS. 6A and 6B.

As shown in FIG. 6A, the laser beam (P-polarization) in parallel light passes directly through the polarizing diffraction element 106, and the laser beam is incident on the liquid crystal lens 107. Because the liquid crystal lens 107 is turned off, the liquid crystal lens 107 does not have the lens action on not only the outer circumferential portion but also the inner circumferential portion in the laser beam, and the laser beam is incident on the objective lens 109 in parallel light. Then, the laser beam is caused to converge on one point by the objective lens. In this case, only one S-shape curve is generated on the focus error signal, so that the laser beam can be focused on the BD recording surface by performing the focus pull-in operation to the S-shape curve.

The laser beam which is caused to converge on the BD recording surface follows a path shown in FIG. 6B after being reflected from the BD recording surface. That is, the reflected light is incident on the liquid crystal lens 107 through the objective lens 109 and the quarter-wave plate 108. However, because the liquid crystal lens 107 is turned off, the liquid crystal lens 107 has no influence on the reflected light, and the reflected light passes through the liquid crystal lens 107 in parallel light. Then, the reflected light is incident on the diffraction structures 106b1 and 106b2 in the polarizing diffraction element 106. Because the reflected light is in the S-polarization state unlike the case in which the light is incident on the disk, the diffraction structures 106b1 and 106b2 have the lens action (diffuse action) on the reflected light.

The diffraction structure 106b1 separates an inner circumferential portion of the reflected light into the light (0-order light) which travels in parallel light and the light (1-order light) which diffuses from the parallel light. The diffraction structure 106b2 separates an outer circumferential portion of the reflected light into the light (0-order light) which travels in parallel light and the light (+1-order light) which diffuses and converges from the parallel light. As described above, because the position of the light receiving surface of the photodetector 113 is adjusted so as to receive the reflected light in parallel light which is incident on the collimate lens 103, the light (0-order light) which travels in a straight line is caused to converge onto the light receiving surface of the photodetector 113. At this point, because the diffraction efficiency of the 0-order light in the diffraction structure 106b2 on the outer circumference side is adjusted so as to be equalized to the diffraction efficiency of the 0-order light in the diffraction structure 106b1 on the inner circumference side, a light quantity ratio between the 0-order light in the inner circumferential portion and the 0-order light in the outer circumferential portion is unchanged from immediately before the reflected light is incident on the polarizing diffraction element 106. Therefore, as shown in FIG. 6B, the light reflected from the BD is caused to converge uniformly on the photodetector 113 with the even light quantity.

In this case, it is assumed that the 1-order light generated by the diffraction structure 106b1 and the ±1-order light generated by the diffraction structure 106b2 is incident on the photodetector 113. However, the 1-order light and the ±1-order light become remarkably fuzzy on the light receiving surface of the photodetector 113, so that the 1-order light and the ±1-order light have the little influence on the sensor signal even if the 1-order light and the ±1-order light are incident on the photodetector 113.

As described above with reference to FIGS. 5 and 6, according to the embodiment, the laser beam can be caused to converge smoothly on the HD and the BD by performing the ON/OFF control of the liquid crystal lens 107, and the reflected light from the HD and the reflected light from the BD can smoothly be received with the common photodetector 113. According to the embodiment, the HD and the BD can be irradiated with the laser beam in the state of the circularly polarized light, so that the laser beam aberration generated on the recording surface can be suppressed. According to the embodiment, the light path of the light reflected from the HD and the BD is changed in the direction of the photodetector 113 by the combination of the polarization beam splitter 102 and the quarter-wave plate 108, so that utilization efficiency of the laser beam can be enhanced.

According to the embodiment, in the path through which the laser beam proceeds to the disk, the laser beam passes through the liquid crystal lens 107 only once, so that the HD and the BD can be irradiated with high-power laser beam while the decrease in power caused by the liquid crystal lens is suppressed.

In the above embodiment, in the diffraction structures formed in the polarizing diffraction element 106, the diffraction structure 106b1 on the inner circumference side is formed by the blaze-type diffraction structure. Alternatively the blaze-type diffraction structure can be replaced with the step-type diffraction structure.

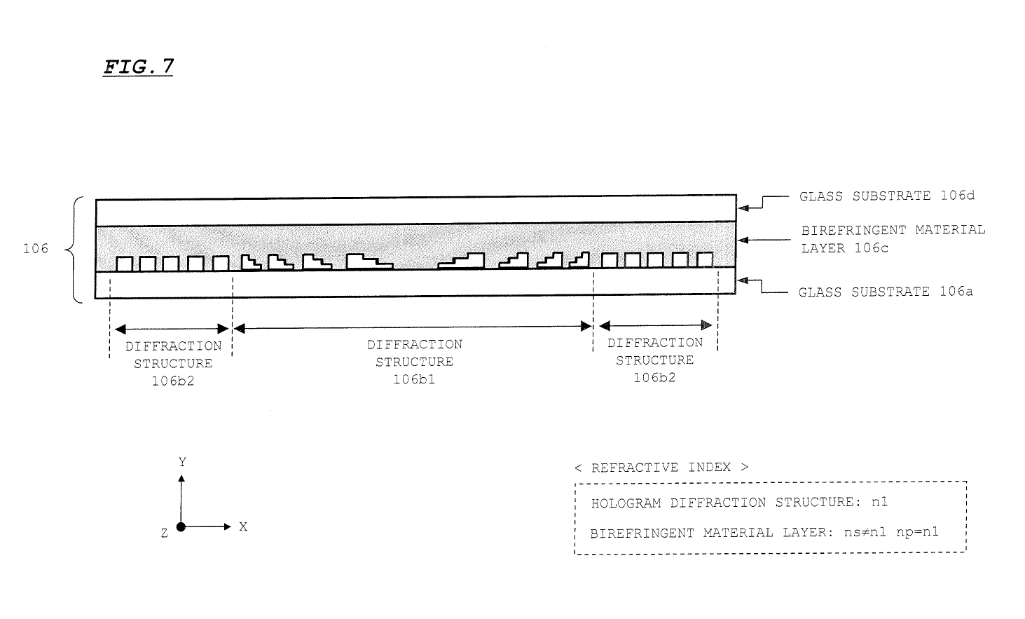

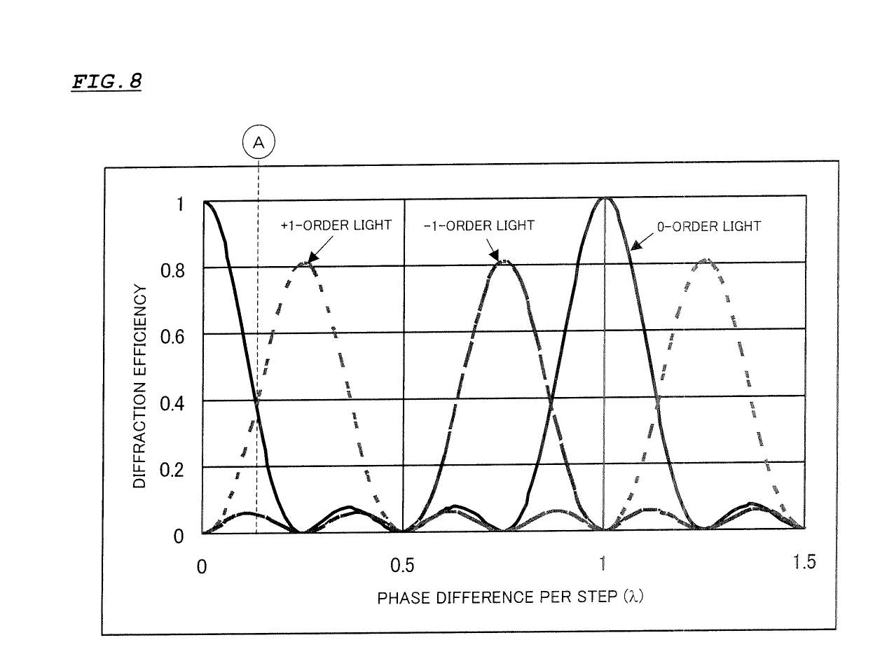

FIG. 7 is a sectional view showing a configuration example when the diffraction structure 106b1 is formed by the step-type diffraction structure (four steps). FIG. 8 shows a simulation result of a relationship between a phase difference per step and the diffraction efficiency for the four-step diffraction structure. As can be seen from FIG. 8, when the phase difference per step is set to a position A in FIG. 8, the diffraction efficiency of the 0-order light and the diffraction efficiency of the 1-order light can be set to about 0.4 like the above embodiment.

In the above embodiment, the 0-order light and the diffraction efficiency of the 1-order light are equalized to each other in the diffraction structure 106b1. Alternatively, one of the 0-order light and the diffraction efficiency of the 1-order light may be set larger than the other. For example, in the embodiment, when the liquid crystal lens 107 is turned on, because the aperture is restricted in the outer circumferential portion of the laser beam, the reflected light quantity incident on the photodetector 113 is decreased compared with the case in which the liquid crystal lens 107 is turned off. Therefore, the 1-order light may be set larger than the diffraction efficiency of the 0-order light in the diffraction structure 106b1.

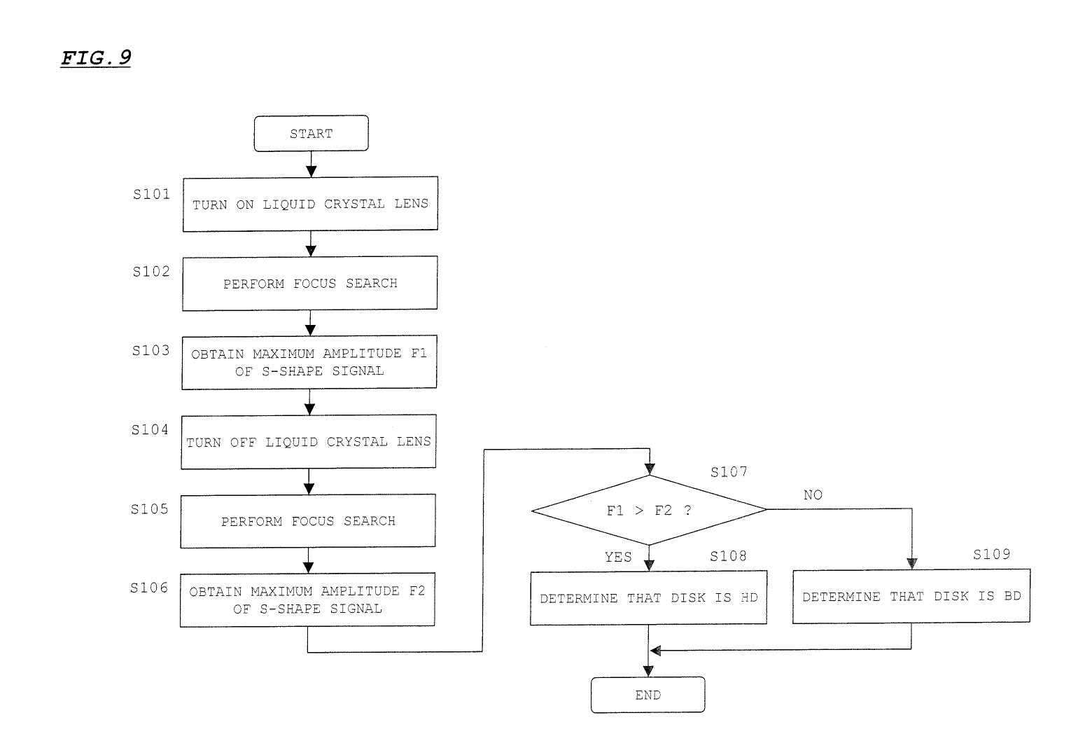

A disk determination method for determining between the HD and the BD of the loaded disks will be described with reference to FIG. 9. As described above, the controller 204 performs the determination process.

When the disk determination process is started, the liquid crystal lens 107 is turned on (S101), and focus search is performed (S102). The S-shape curves generated on the focus error signal are compared to each other in the amplitude, and the maximum amplitude F1 is obtained (S103). Then, the liquid crystal lens 107 is turned off (S104) and the focus search is performed (S105). Similarly the S-shape curves generated on the focus error signal are compared to each other in the amplitude, and the maximum amplitude F2 is obtained (S106). Then, the maximum amplitudes F1 and F2 are compared to each other (S107). When the maximum amplitude F1 is more than the maximum amplitude F2 (YES in S107), the controller 204 determines that the loaded disk is the HD (S108). When the maximum amplitude F1 is not more than the maximum amplitude F2 (NO in S107), the controller 204 determines that the loaded disk is the BD (S109). When the controller 204 determines that the loaded disk is the HD, the liquid crystal lens 107 is set to the ON-state. On the other hand, when the controller 204 determines that the loaded disk is the BD, the liquid crystal lens 107 is set to the OFF-state.

The disk determination process shown in the flowchart of FIG. 9 utilizes the large S-shape curve which is generated on the focus error signal when the liquid crystal lens 107 is in the driving state corresponding to the reproduction target disk.

As described above, when the liquid crystal lens 107 is turned on, because the aperture restriction action is imparted to the laser beam, the light quantity received by the photodetector 113 is decreased compared with the case in which the liquid crystal lens 107 is turned off. Accordingly, it is necessary that the comparison in S107 be performed in the state the difference in light quantity is balanced out.

Given that P1 and P2 are light quantities of laser beams guided to the photodetector 113 when the liquid crystal lens 107 is turned on and off respectively, a correction coefficient is multiplied by the maximum amplitude F1 according to a ratio of P1 and P2, and the maximum amplitude F1 is determined when the light quantity P1 is assumed to be equal to the light quantity P2. In S107, the determined maximum amplitude F1 is compared to the maximum amplitude F2 obtained in S106, and the determination between the HD and the BD of the target disks is made according to the comparison result.

The present invention is not limited to the embodiment, but various modifications can be made.

For example, in the embodiment, the diffraction structure 106b2 in the polarizing diffraction element 106c is formed by the step-type diffraction structure. Alternatively, the diffraction structure 106b2 may be formed by other diffraction structures except for the step-type diffraction structure. However, as described above, desirably the diffraction efficiency of the 0-order light of the diffraction structure 106b2 is matched with the diffraction efficiency of the 0-order light of the diffraction structure 106b1. In the embodiment, the diffraction structure 107b in the liquid crystal lens 107 is formed by the blaze-type diffraction structure. Alternatively, for example, the diffraction structure 107b may be formed by the step-type diffraction structure. In this case, desirably the phase difference per step is set such that the diffraction efficiency of the +1-order light becomes the maximum.

Various modifications of the present invention can be made without departing from the scope of the technical idea disclosed in claims of the present invention.

What is claimed is:

1. An optical pickup device comprising:
a light source which emits a laser beam having a predetermined wavelength;
a polarization beam splitter on which the laser beam is incident;
an objective lens which causes the laser beam through the polarization beam splitter to converge;
a quarter-wave plate which is disposed between the polarization beam splitter and the objective lens;
a liquid crystal lens which is disposed between the polarization beam splitter and the quarter-wave plate to switch between a first driving state and a second driving state, diffuse action being imparted to the laser beam by a control signal in the first driving state, diffuse action being not imparted to the laser beam in the second driving state;
a photodetector which accepts light reflected from a disk; and
a polarizing diffraction element which is disposed between the photodetector and the liquid crystal lens,
wherein the polarizing diffraction element is configured such that a focal distance of diffracted light having a predetermined order of the reflected light when the liquid crystal lens is in the first driving state is equalized to a focal distance of 0-order diffracted light of the reflected light when the liquid crystal lens is in the second driving state.

2. The optical pickup device according to claim 1, wherein a collimate lens is disposed between the light source and the polarizing diffraction element.

3. The optical pickup device according to claim 1, wherein the liquid crystal lens imparts the diffuse action only to an inner circumferential portion of the incident laser beam.

4. The optical pickup device according to claim 3, wherein, in the polarizing diffraction element, a diffraction structure is disposed in a region through which at least the inner circumferential portion of the laser beam passes, the focal distance of the diffracted light having the predetermined order being equalized to the focal distance of the 0-order diffracted light in the diffraction structure.

5. The optical pickup device according to claim 4, wherein, in the polarizing diffraction element, a diffraction structure is disposed outside of a region through which the inner circumferential portion of the incident laser beam passes, diffraction efficiency of 0-order diffracted light being equalized to diffraction efficiency of the 0-order diffracted light in the inner circumferential portion.

6. The optical pickup device according to claim 5, wherein a collimate lens is disposed between the light source and the polarizing diffraction element.

7. An optical disk device comprising:
an optical pickup device including:
a light source which emits a laser beam having a predetermined wavelength;
a polarization beam splitter on which the laser beam is incident;
an objective lens which causes the laser beam through the polarization beam splitter to converge;
a quarter-wave plate which is disposed between the polarization beam splitter and the objective lens;
a liquid crystal lens which is disposed between the polarization beam splitter and the quarter-wave plate to switch between a first driving state and a second driving state, diffuse action being imparted to the laser beam by a control signal in the first driving state, diffuse action being not imparted to the laser beam in the second driving state;
a photodetector which accepts light reflected from a disk; and
a polarizing diffraction element which is disposed between the photodetector and the liquid crystal lens,
wherein the polarizing diffraction element is configured such that a focal distance of diffracted light having a predetermined order of the reflected light when the liquid crystal lens is in the first driving state is equalized to a focal distance of 0-order diffracted light of the reflected light when the liquid crystal Ions is in the second driving state;
a servo circuit which supplies the control signal to the liquid crystal lens; and
a disk determination circuit which makes a determination between types of the loaded disks to supply a signal to the servo circuit according to determination result.

8. The optical disk device according to claim 7, wherein a collimate lens is disposed between the light source and the polarizing diffraction element.

9. The optical disk device according to claim 7, wherein the liquid crystal lens imparts the diffuse action only to an inner circumferential portion of the incident laser beam.

10. The optical disk device according to claim 9, wherein, in the polarizing diffraction element, a diffraction structure is disposed in a region through which at least the inner circumferential portion of the laser beam passes, the focal distance of the diffracted light having the predetermined order being equalized to the focal distance of the 0-order diffracted light in the diffraction structure.

11. The optical disk device according to claim 10, wherein, in the polarizing diffraction element, a diffraction structure is disposed outside of a region through which the inner circumferential portion of the incident laser beam passes, diffraction efficiency of 0-order diffracted light being equalized to the diffraction efficiency of the 0-order diffracted light in the inner circumferential portion.

12. The optical disk device according to claim 11, wherein a collimate lens is disposed between the light source and the polarizing diffraction element.
